(19) United States
(12) Patent Application Publication
(10) Pub. No.: US 2020/0016920 A1
(43) Pub. Date: Jan. 16, 2020

(54) Folder with lock wings

(71) Applicant: Bon S. Ong, Torrance, CA (US)

(72) Inventor: Bon S. Ong, Torrance, CA (US)

(21) Appl. No.: 15/998,163

(22) Filed: Jul. 11, 2018

(51) Int. Cl. B42F 7/06

(52) U.S. Cl. CPC B42F 7/06; B42P 2241/02

(57) ABSTRACT

A file folder having front and back covers delineated from each other by a spine therebetween is formed with a pocket located at the outboard edge of at least one of the front and back covers. The pocket has closures at the top and bottom edges and also at the outboard edge of the cover upon which it is formed. The pocket has a mouth that opens toward the spine. At least one lock wing is formed by a patch of stiff material having a fixed portion secured to the cover having the pocket at the spine. The lock wing also has a free portion that extends toward the mouth of the pocket and forms an acute angle with the cover to which the lock wing is secured. Papers, media, or other contents can be inserted into the open mouth of the pocket and the lock wing can be resiliently flexed to receive the inboard extremity of the pocket contents beneath it. The contents of the pocket are thereby securely held in the pocket by the constraints of the pocket closures and the lock wing.

### BACKGROUND OF THE INVENTION

### Field of the Invention

The present invention relates to file folders of the type widely used throughout many avenues of commerce. Such folders are widely used to hold papers, reports, promotional flyers, computer disks and other media and numerous other relatively flat objects. Such folders are often formed from a single sheet of relatively stiff material that is folded to form front and back covers delineated by a spine therebetween.

### Description of the Prior Art

One problem frequently encountered in using simply constructed conventional folders is that the flat contents of the folders often tends to slip out from the top, bottom or open side of the folder opposite the spine. To solve this problem folders have for many years been constructed with pockets that partially constrain the folder contents from sliding out from between the front and back covers. Pockets are often formed along the bottom edge of either or both of the front and back covers. Such folders with bottom pockets have been used for many years, and do constrain the folder contents from sliding out the sides or bottom of the folder. One such folder is sold commercially as the Avery Model #47986 folder. However, the contents of conventional folders such as this frequently slide out of the top of the folder from the open mouth of the pocket. This is likely to occur when the folder is dropped or during transport. The same is true of the Staples Model #26185 Two-Pocket with Three-Hole Punched Folder. This folder has side openings to its pockets so that the documents also tend to slide from one pocket across the spine toward the pocket on the other side when opening the folder.

To attempt to remedy this problem some folders have been constructed with side, top or corner tabs as extensions from the sheet of material forming the cover. The side and top tabs are folded over the outer and top edges of the folder contents. The top, outer corners of the folder contents are inserted beneath the corner tabs. One such folder that is commercially available is the Avery Model #47759 folder. This folder has two pockets, side-by-side, one on the front cover and one on the back cover. Both pockets have side openings facing the spine While this structure does provide some constraint of the folder contents, it makes removal of the folder contents rather difficult. Also, documents tend to slide from one pocket across the spine to the other pocket when the folder is opened. The same is true of a variation of this structure sold commercially as the Mead Stay-Put Tabs folder Model #37401 folder and also the Mead Model #33100 Folder with Trapper-Keeper pockets at both top and bottom.

Another folder structure which has been utilized employs a contoured slit near the top of one of the covers. The slit is articulately curved to form a top retaining tab that is directed toward the upwardly opening mouth of the folder pocket. One commercial embodiment of such a folder is sold as the Oxford Contour Model #5062558 folder with cut-out lock tab. While this top retaining tab does serve as a slight constraint to prevent the folder contents from sliding out of the pocket from the top of the folder, it structurally weakens the top of the cover upon which the pocket is formed. As a consequence, the weight of the folder contents readily bends the top retaining tab back so that the folder contents easily slide past it. Furthermore, the tops of documents in the folder are exposed on the outside of the folder, which is aesthetically unappealing. In addition, the exposed portions of the documents on the outer surface of the cover can snag on other papers or articles with which the folder comes in contact.

Another type of prior art folder employs an extension from the sheet of folder material at the tops of both covers where they meet at the spine. This extension is bent over the top portion of the folder contents immediately adjacent to the spine. One commercial product so constructed is sold as Smead Lock-It Model #87980 folder with extended top fold down tab. This type of folder also has certain disadvantages. The flexible lock tab of this product tends to pop up or become crumpled when closing the folder. Also, one needs to hold down the top fold down tab when closing the folder.

### SUMMARY OF THE INVENTION

In one broad aspect the present invention may be considered to be a file folder comprising front and back covers with a first pocket formed on a first of the covers and at least one lock wing. The front and back covers both have top and bottom edges and both covers have an outboard edge. The front and back covers extend in opposite directions to their respective outboard edges from a spine formed as a demarcation between the covers. The first pocket is closed at the outboard edge of the first cover and also closed at the top and bottom edges of the first cover. The lock wing has a free portion and a fixed portion. The fixed portion of the lock wing is secured to the first cover at the spine and the free portion of the lock wing is directed toward the first pocket and is formed of a stiff material that is flexible enough to be resiliently moved away from the first cover. This resiliency allows the distance of separation to vary between the free portion of the lock wing and the first cover.

In another broad aspect the invention may be considered to be a file folder formed of a sheet of cover material that is folded to define a linear spine. The spine divides the sheet of cover material into opposing front and back covers. Both covers have outboard edges located remote from and parallel to the spine. Both covers have top and bottom edges perpendicular to and extending between the outboard edges and the spine. At least one of the covers has a pocket formed thereon. The pocket has closures at the outboard edge and at the top and bottom edges of the cover upon which it is formed. The pocket has an open mouth facing the spine. At least one lock wing formed of a stiff material is secured to a cover upon which a pocket is formed. The lock wing has a free portion directed toward the open mouth of the pocket on the cover to which the lock wing is secured. The lock wing is resiliently deflectable outwardly from the cover to which the lock wing is secured.

In a preferred embodiment the file folder of the invention is comprised of front and back covers formed from a flat sheet of cover material both having pockets formed thereon. A pair of lock wings are attached to the front and back covers. Both covers have top and bottom edges and an outboard edge. The front and back covers are delineated from each other at a linear spine formed by a fold in the flat sheet of material. Both covers have top and bottom edges and an outboard edge. The pockets both have closures at the outboard edges of the respective covers upon which they are formed. Both pockets have mouth openings facing the spine. The pockets extend between and are secured to the top and bottom edges of the respective covers on which they are formed. The lock wings are both formed of a stiff material and have free portions each directed toward a different one of the pockets. The free portions are resiliently deflectable away from the respective cover to which each lock wing is attached. The distance of separation between the free portions of the lock wings and the respective cover to which each of the lock wings is attached may thereby be varied.

The invention may be described with greater clarity and particularity by reference to the accompanying drawings.

### DESCRIPTION OF THE DRAWINGS

FIG. 1 is a perspective view of one preferred embodiment of the file folder of the invention shown with papers in both of its pockets.

FIG. 2 is a top plan view of the file folder of FIG. 1.

FIG. 3 is a sectional elevational view taken along the lines 3-3 of FIG. 2.

FIG. 4 is a top plan view of the sheet of cover material shown in isolation prior to folding to form the pockets of the file folder of FIG. 1.

FIG. 5 is a top plan view of the locking wings of the file folder of FIG. 1 shown in isolation.

FIG. 6 is a sectional elevational view showing the manner of attachment of the lock wings of FIG. 5 to the sheet of cover material once the cover material has been folded to form the pockets of the file folder of FIG. 1.

FIG. 7 Is an enlarged detail of a portion of the folder of the invention indicated at 7 in FIG. 6, following attachment of the lock wings to the covers and with both cover pockets empty.

### DESCRIPTION OF THE EMBODIMENT

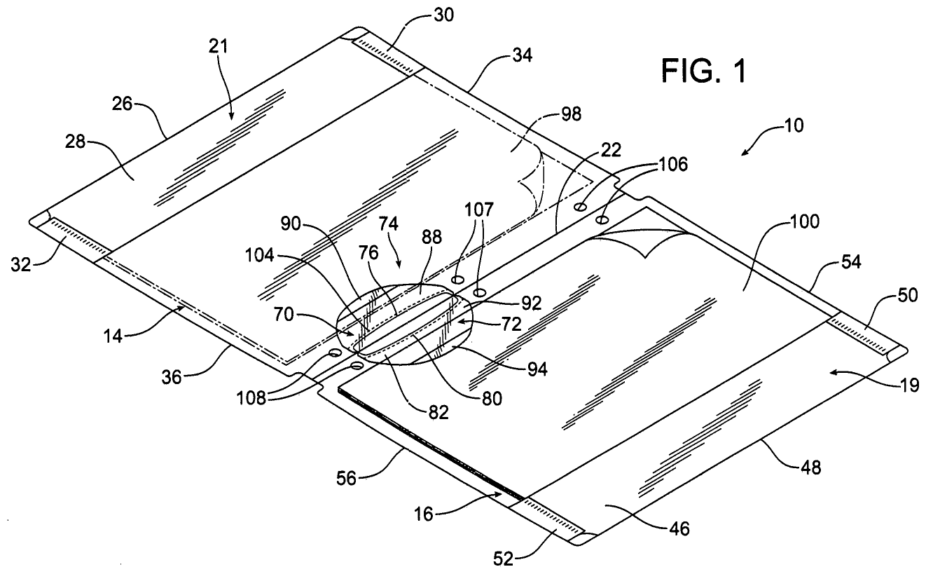

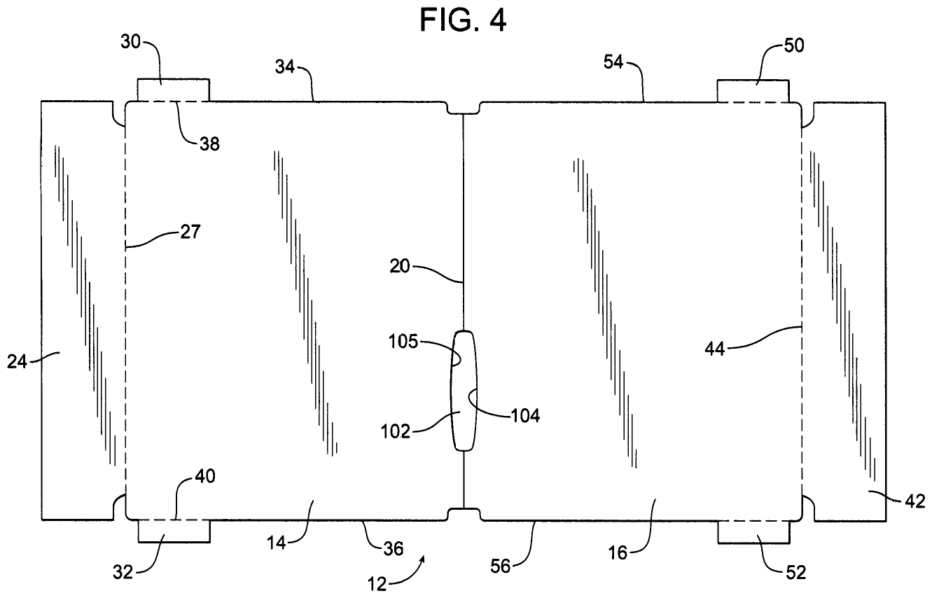

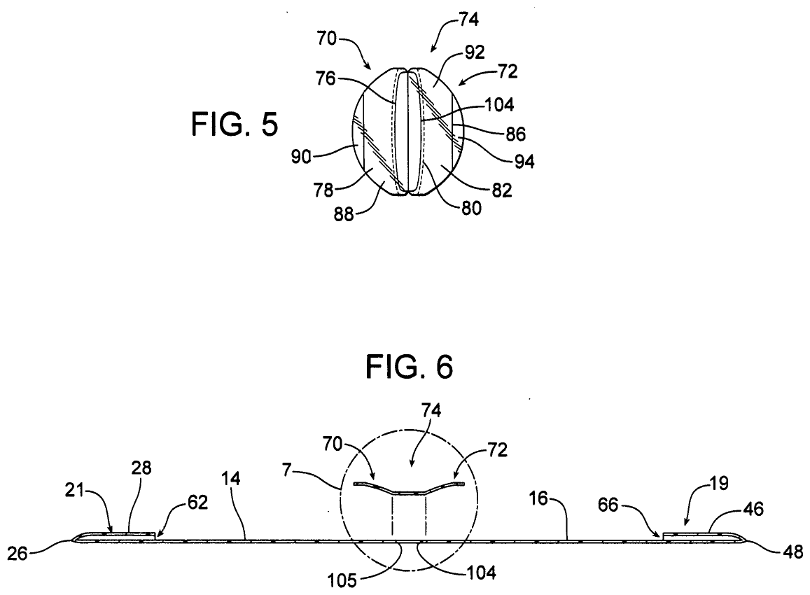

FIG. 1 illustrates a file folder indicated generally at 10 which is formed of a single sheet of stiff but somewhat flexible file cover material 12, such as polyethylene or polypropylene plastic, or thick paper card stock, typically 5-20 mills in thickness. The sheet of file cover material 12 is illustrated in isolation in FIG. 4 as it is cut from a larger sheet and prior to folding. The sheet of cover material 12 is folded longitudinally at its center to define a front cover 14 and a back cover 16 delineated from each other by a center fold 20 forming a spine 22. The spine 22 divides the sheet of cover material 12 into mirror image sections forming the front cover 14 and back cover 16. A first pocket 19 is formed on a first of the covers 14 and 16, for example the back cover 16. The first back cover pocket 19 has closures on three of its sides and a mouth opening 66 facing the spine 22. Preferably the other second cover, for example the front cover 14, has a second mirror image pocket 21 formed thereon.

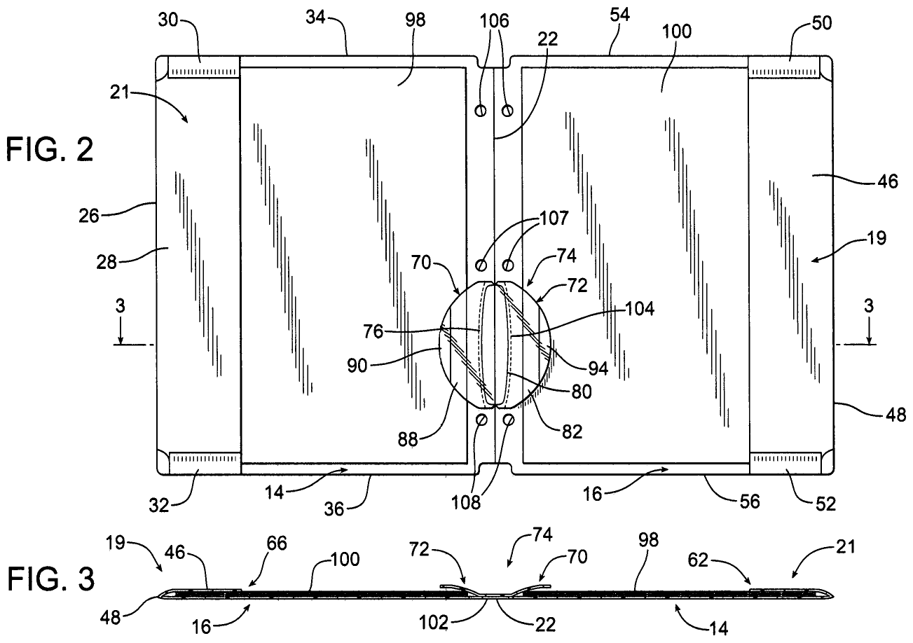

The section of the sheet of cover material 12 forming the front cover 14 has a generally rectangular front cover pocket panel extension flap 24 that is elongated parallel to the spine 22, as shown in FIG. 4. The front pocket panel extension flap 24 is folded back toward the spine 22 along the fold line 27 to form an outboard edge 26 of the front cover 14 and a generally rectangular pocket panel 28, as shown in FIGS. 1 and 2. The pocket panel 28 extends toward the spine 22 from the outboard edge 26 of the front cover 14. The fold at the outboard edge 26 forms a pocket 21 with a closure at the outboard edge 26.

The sheet of cover material 12 is also formed with a top extension tab 30 and a bottom extension tab 32 at the top edge 34 and bottom edge 36 of the front cover 14, respectively, as shown in FIG. 4. The top and bottom extension tabs 30 and 32 are respectively folded over at the fold lines 38 and 40 to positions atop the pocket panel 28 after the pocket panel 28 has been folded back toward the spine and 22, as shown in FIGS. 1 and 2. The top and bottom extension tabs 30 and 32 are then permanently secured to overlie the pocket panel 28 by any conventional means. Securement may be by fusion accomplished by sonic welding if the sheet of cover material 12 is formed of plastic. Alternatively, if the sheet of cover material 12 is formed of heavy paper card stock, the top and bottom pocket tabs 30 and 32 may be secured to the pocket panel 28 by adhesive.

In the preferred embodiment of the invention there is a back pocket panel extension flap 42 from the back cover 16 remote from the spine 22. The back panel extension flap 42 is folded back towards the spine 22 along the fold line 44 that is parallel to the fold lines 20 and 27, as shown in FIG. 4. The extension flap 42, when folded back, forms a pocket panel 46 on the back cover 16, as shown in FIGS. 1 and 2. The outboard edge 48 of the back cover 16 formed by the fold of the pocket panel 46 at the fold line 44 thereby forms a pocket closure at the outboard edge 48 of the back cover 16.

The section of the sheet material 12 forming the back cover 16 also has top and bottom extensions 50 and 52 projecting in opposite directions from each other from the top edge 54 and the bottom edge 56 of the back panel 16, respectively, as shown in FIG. 4. The top and bottom extensions 50 and 52, once folded over the pocket panel 46, form top and bottom closures for the pocket 19 formed on the back cover 16, as shown in FIGS. 1 and 2. The top and bottom pocket extension tabs 50 and 52 are secured atop the back cover pocket panel 46 in a conventional manner, in the same way that the top and bottom pocket tabs 30 and 32 are secured to the front cover pocket panel 28.

The front cover pocket panel 28, together with the top and bottom tabs 30 and 32, when folded over and secured to each other as illustrated in FIG. 1 together form the front pocket 21 with closures at both the top and bottom edges 34 and 36 and the outboard edge 26 of the front cover 14. The front cover pocket 21 has an open mouth 62 that faces the spine 22. Likewise, the pocket panel 46 and top and bottom pocket extension tabs 50 and 52, when folded and secured as illustrated in FIG. 1, form the back cover pocket 19 that has an open mouth 66 facing the spine 22. The outboard edges 26 and 48 of the front cover 14 and back cover 16, respectively, are parallel to each other and are remote from and parallel to the spine 22. The top and bottom edges 34 and 36 are perpendicular to the outboard edge 26 of the front cover 14 and extend between the outboard edge 26 and the spine 22. Likewise, the outboard edge 48 of the back cover 16 lies remote from and parallel to the spine 22. The top edge 54 and the bottom edge 56 of the back cover 16 are also perpendicular to the outboard edge 48 and the spine 22 and extend therebetween.

In the preferred embodiment, both the front cover 14 and the back cover 16 of the file folder 10 are each provided with a pocket, namely the pocket 21 on the front cover 14 and the pocket 19 on the back cover 16. However, it is to be understood that it is necessary only that at least one of the front and back covers 14 and 16 has a pocket. The other cover could be just a flat section of the sheet of cover material 12 having only a single layer of uniform thickness throughout.

The file folder 10 has at least one, and preferably a pair of lock wings 70 and 72. The front cover lock wing 70 and the back cover lock wing 72 are formed of a single patch 74 of stiff material, such as transparent polypropylene plastic between 5 and 20 mils in thickness: The front cover lock wing 70 has a fixed portion 76 and a free portion 78. Likewise, the back cover lock wing 72 also has a fixed portion 80 and a free portion 82. The free portion 78 of the front cover lock wing 70 is directed toward the front pocket 21 on the front cover 14. The front cover lock wing 70 is flexible enough to be resiliently moved away from the first, front cover 14 to vary the distance of separation between the free portion 78 of the front cover lock wing 70 and the first, front cover 14. Likewise, the lock wing 72 is flexible enough to be resiliently moved away from the back cover 16 to vary the distance of separation between the free portion 82 of the lock wing 72 and the back cover 16. The lock wings 70 and 72 can thereby accommodate and capture file contents of different thicknesses.

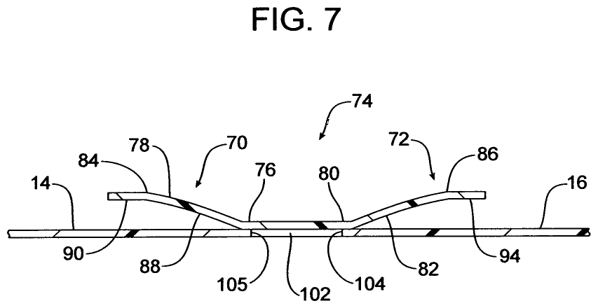

In the preferred embodiment of the invention illustrated the free portions 78 and 82 of the lock wings 70 and 72, respectively, are divided parallel to the spine 22 by demarcations 84 and 86. The demarcation 84 divides the free portion 78 of the front cover lock wing 70 into a pinching tab 88 immediately adjacent to the fixed portion 76, and a contents engaging tab 90 at the outboard extremity of the front cover lock wing 70, as best illustrated in FIG. 7. The pinching tab 88 resides at a first acute angle, preferably about 20° and no greater than about 5° relative to the plane of the front cover 16. The contents engaging tab 90 resides at a second acute angle relative to the front cover 14 that is smaller than the first acute angle of the pinching portion 88 relative to the plane of the front cover 14. That is, the contents engaging tab 90 preferably resides at an angle of less than 20° relative to the plane of the front cover 14.

Likewise, the delineation 86 on the back cover locking the wing 72 divides the free portion 82 into a pinching tab 92 and a contents engaging tab 94. With the pocket 19 empty, the pinching tab 92 resides at an acute angle, preferably about 20° and no greater than about 30°, relative to the plane of the back cover 16. The contents engaging tab 94 resides at a second acute angle, smaller than the first acute angle. That is, the contents engaging tab 94 preferably resides at an angle of less than 20° relative to the plane of the back cover 16.

To utilize the file folder 10, the file folder contents, for example several sheets of paper indicated as a stack of papers 98 in FIGS. 1, 2 and 3, are inserted into the folder 10 by sliding them laterally from above the spine 22 outwardly therefrom and into the side opening mouth 62 of the front cover pocket 21. Once the outboard edges of the stack of papers 98 are fully inserted into the pocket 21, the inboard edges of the stack of papers 98 are flexed slightly, then inserted into the gap between the front cover lock wing 70 and the front cover 14, From left to right, with reference to FIG. 3. The stack of papers 98 is then released. The contents engaging tab 90 is stiff enough and sufficiently separated from the front cover 14 to channel the inboard edges of the stack of papers 98 into the space between the pinching portion 88 of the lock wing 70 and the front cover 14. Because the distance of separation of the pinching portion 88 is less than the distance of separation of the contents engaging portion 90 from the front cover 14, the pinching portion 88 tends to clamp the inboard edges of the stack of papers 98 against the inner surface of the front cover 14. The stack of papers 98 is thereby securely held in position in the file folder 10. The pocket panel 28 and the pocket extension tabs 30 and 32 of the front cover pocket 21 prevent the stack of papers 98 from sliding out of the folder in either an outboard direction or from either the top or bottom of the front cover 14. The clamping action of the front cover lock wing 70 prevents the stack of papers 98 from sliding out of the pocket 21 in a direction toward the spine 22.

Similarly, another stack of papers 100 can likewise be held in the back cover pocket 19. The outboard edges of the stack of papers 100 are inserted into the open mouth 66 of the back cover pocket 19 from left to right, as viewed in FIG. 3. The inboard edges of the stack of papers 100 are then flexed and inserted into the gap between the contents engaging tab 94 of the back cover lock wing 72 and the inner surface of the back cover 16. The contents engaging tab 94 of the free portion 82 of the lock wing 72 guides the inboard edges of the stack of papers 100 into the space between the back cover lock wing 72 and the inner surface of the back cover 16. The pinching portion 92 of the lock wing 72 thereby tends to securely grip the inboard edges of the stack of papers 100 and prevent them from sliding out of the back cover pocket 19.

The file folder 10 of the invention is preferably, but not necessarily, comprised of a window 102 cut out of the structure of the sheet of cover material 12 at a location along the spine fold 20. The window 102 is formed as adjacent openings 104 and 105 cut out from the front cover 14 and back cover 16, respectively, on either side of the spine 22. The window 102 is located directly beneath the patch 74 of stiff material forming the lock wings 70 and 72.

The fixed portions 76 and 80 of the lock wings 70 and 72 are respectively secured to the front cover 14 and back cover 16, about the perimeter of the window 102. In the embodiment illustrated a sonic weld secures the fixed portions 76 and 80 of the lock wings 70 and 72 to the structures of the front cover 14 and back cover 16 in an elongated ring shaped seal 104 that has a generally elongated oval shape about the perimeter of the window 102, as illustrated in the drawings.

The patch 74 forming the lock wings 70 and 72 is linearly aligned with and superimposed upon the portion of the spine 22 at the window 102. The fixed portions 76 and 80 of the lock wings 70 and 72 are secured to the covers 14 and 16 near the spine 22 and directly atop the window 102. The purpose of the window 102 is to slightly reduce the thickness of the overall structure of the folder 10 at the location of the patch 74 on the spine 22. That is, the double thickness of the sheet of cover material 12 and the patch 14 is avoided at the location of the window 102. This makes the folder 10 easier to close fully with contents occupying the pockets 19 and 21.

Preferably, the front and back covers 14 and 16 of the file folder 10 are perforated by three sets of mirror image holes 106, 107 and 108. The sets of holes 106, 107 and 108 are spaced about 10.8 cm apart in a direction parallel to the spine 22. Each of the holes 106, 107 and 108 is preferably spaced about 0.63 cm in distance from the spine 22. The holes 106, 107 and 108 are each about 0.8 cm in diameter.

The purpose and spacing of the holes 106, 107 and 108 is to allow the file folder 10 to be secured within a conventional three ring binder. Such three ring binders are widely available in stationery and office supply stores and typically are constructed with 1 inch, 2 inch and 3 inch width spines.

The window 102 and the single patch 74 of stiff material forming the lock wings 70 and 72 are located closer to the bottom edges 36 and 56 of the front and back covers 14 and 16 than to the top edges 34 and 54. By positioning the lock wings 70 and 72 on the lower portions of the covers 14 and 16, the upper inboard corners of the individual pages in the stack of papers 98 and 100 can be folded back as illustrated in FIG. 1. This allows the user to easily locate and identify pages of particular interest without taking all of the papers out of the pockets.

FIG. 4 illustrates the sheet of cover material 12 prior to punching the holes 106, 107 and 108. Unless the file folder 10 is to have the capability of being placed in a three ring binder, the holes are unnecessary, Rather, they are an optional feature and do not form an essential part of the invention.

Undoubtedly, numerous variations and modifications of the invention will become readily apparent to those familiar with file folders and their uses. Accordingly, the scope of the invention should not be construed as limited to this specific embodiments depicted and described, but rather is defined in the claims appended hereto.

I claim:

1. A file folder comprising:
a front cover and a back cover both having top and bottom edges and both covers have an outboard edge and said front and back covers extend in opposite directions to their respective outboard edges from a spine formed as a demarcation between said covers,
a first pocket formed on a first of said covers, said pocket being closed at said outboard edge of said first cover and also closed at said top and bottom edges of said first cover,
at least one lock wing having a free portion and a fixed portion and said fixed portion of said lock wing is secured to said first cover at said spine and said free portion of said at least one lock wing is directed toward said a first pocket and said at least one lock wing is formed of a stiff material and is flexible enough to be resiliently moved away from said first cover to vary the distance of separation between said free portion of said at least one lock wing and said first cover.

2. A file folder according to claim 1 wherein said first cover is said back cover and said a first pocket is a back cover pocket and said at least one lock wing is a back cover lock wing.

3. A file folder according to claim 2 wherein said front cover also has a front cover pocket formed thereon which is a second pocket, said front cover pocket being closed at said outboard edge and closed at said top and bottom edges of said front cover, and further comprising a front cover lock wing having a free portion and a fixed portion, and said fixed portion of said front cover lock wing is secured to said front cover at said spine and said free portion of said front cover lock wing is directed toward said front cover pocket and said front cover lock wing is formed of a stiff material and is flexible enough to be resiliently moved away from said front cover to vary the distance of separation between said free portion of said front cover lock wing and said front cover.

4. A folder according to claim 3 wherein said front and back cover lock wings are formed of a single patch of said stiff material and said lock wings are formed as mirror image structures of each other by a linear delineation aligned with and superimposed upon a portion of said spine, and said fixed portions of said lock wings are secured to said covers near said spine.

5. A file folder according to claim 4 further comprising a window formed as adjacent openings cut out from said front and back covers on either side of said spine directly beneath said patch of said stiff material, and said fixed portions of said lock wings are secured to both said covers about the perimeter of said window.

6. A file folder according to claim 5 wherein said window and said single patch of stiff material are located closer to said bottom edges of said front and back covers then to said top edges of said front and back covers.

7. A file folder according to claim 1 wherein both said covers and said at least one lock wing are formed of stiff plastic wherein said fixed portion of said at least one lock wing is fused to said first cover.

8. A file folder according to claim 1 wherein both said covers and said at least one lock wing are formed of stiff paper card stock and said fixed portion of said at least one lock wing is secured to said first cover by adhesive.

9. A file folder according to claim 1 wherein said front and back covers are both perforated by 3 mirror image holes near said spine spaced about 10.8 cm apart parallel to said spine and about 0.63 cm in distance from said spine.

10. A file folder comprising:
front and back covers both formed from a flat sheet of cover material, both covers having top and bottom edges and an outboard edge, and said front and back covers are delineated from each other at a linear spine formed by a fold in said flat sheet of material,
pockets formed on both said front and back covers, said pockets both having closures at said outboard edges of the respective covers upon which they are formed and both pockets having mouth openings facing said spine and said pockets extend between and are secured to said top and bottom edges of the respective covers on which they are formed, and
a pair of lock wings attached to said front and back covers at said spine and said lock wings are both formed of a stiff patch of material and have free portions each directed toward a different one of said pockets and said free portions are resiliently deflectable away from the respective cover to which each lock wing is attached to vary the distance of separation between said free portions of said lock wings and the respective cover to which each of said lock wings is attached.

11. A file folder according to claim 10 wherein said flat sheet of cover material is formed with pocket panels formed as extensions from each of said outboard edges folded over therefrom and directed toward said spine to form said closures at said outboard edges of the respective covers upon which they are formed, and pocket tabs formed as extensions on both of said covers from each of said top and bottom edges near each of said outboard edges, and folded and secured to a pocket panel immediately adjacent thereto to form top and bottom closures for both of said pockets.

12. A file folder according to claim 11 wherein said flat sheet of material is plastic and said top and bottom pocket tabs are fused to said pocket panels.

13. A file folder formed of a sheet of cover material that is folded to define a linear spine that divides said sheet of cover material into opposing front and back covers both having outboard edges located remote from and parallel to said spine, and both covers have top and bottom edges perpendicular to and extending between said outboard edges and said spine,
at least one of said covers has a pocket formed thereon with closures at said outboard edge and at said top and bottom edges of said cover on which said pocket is formed, said pocket having an open mouth facing said spine, and further comprising
at least one lock wing formed of a stiff material and secured to said at least one of said covers and having a free portion directed towards said open mouth of said pocket, and said free portion of said at least one lock wing is resiliently deflectable outwardly from said cover to which said at least one lock wing is secured.

14. A file folder according to claim 13 wherein said sheet of cover material is formed with an extension from said outboard edges of said at least one cover that is folded over at said outboard edge to form a pocket panel that extends toward said spine and forms said closure at said outboard edge, and said sheet of cover material is formed with top and bottom extension tabs at said top and bottom edges respectively of said at least one cover, proximate to said pocket panel, and said top and bottom tabs are folded over and secured to said pocket panel to respectively form said closures at said top and bottom edges of said at least one cover, and
said at least one lock wing is formed of a patch of said stiff material that is secured to said at least one cover at said fixed portion of said at least one lock wing so that said free portion of said at least one lock wing extends toward said pocket from said fixed portion and forms an acute first angle of no greater than 30° relative to said at least one cover.

15. A file folder according to claim 14 wherein said at least one lock wing is formed of a patch of stiff material secured to said at least one cover at a location along said spine spaced from both said top and bottom edges and closer to said bottom edge than to said top edge.

16. A file folder according to claim 15 wherein said sheet of cover material is formed with a window cut out at said location of said patch of stiff material, and said patch of stiff material overlies and covers said window.

17. A file folder according to claim 16 wherein said free portion of said at least one lock wing extends toward said pocket from said fixed portion and forms a first acute angle of no greater than 30° relative to said at least one cover where said patch of stiff material is secured to said at least one cover.

18. A file folder according to claim 17 wherein said free portion of said at least one wing is divided parallel to said spine into a pinching tab immediately adjacent said fixed portion and a contents engaging tab at an outboard extremity of said free portion of said at least one lock wing, and said contents engaging tab resides at a second acute angle relative to said at least one cover and said second acute angle is smaller than said first acute angle.

19. A file folder according to claim 18 wherein said first acute angle is less than 30° and said second acute angle is less than said first acute angle.

20. A file folder according to claim 16 wherein each of said front and back covers are provided with a separate pocket as hereinbefore described and said patch of stiff material forms a lock wing for each of said front and back covers.
